(19) United States
(12) Patent Application Publication
(10) Pub. No.: US 2008/0144906 A1
(43) Pub. Date: Jun. 19, 2008

(54) SYSTEM AND METHOD FOR VIDEO CAPTURE FOR FLUOROSCOPY AND NAVIGATION

(75) Inventors: Joseph J. Allred, Centerville, UT (US); Vernon T. Jensen, Draper, UT (US)

Correspondence Address: RAMIREZ & SMITH, PO BOX 341179, AUSTIN, TX, 78734, US

(73) Assignee: General Electric Company, Schenectady, NY (US)

(21) Appl. No.: 11/539,869

(22) Filed: Oct. 9, 2006

(51) Int. Cl. G06K 9/00

(52) U.S. Cl. 382/131

(57) ABSTRACT

Systems and methods are provided in some embodiments for recording, storage and replay of captured video from a surgical navigation system, a fluoroscopic imaging system, or an integrated fluoroscopy and navigation system. In some embodiments, full resolution video data is captured in an acquisition buffer and is available for replay and storage.

### FIELD OF THE INVENTION

This invention relates generally to medical imaging and navigation systems and more particularly to a system and method for capturing, recording, storing and replaying full resolution video of procedures occurring on medical imaging and navigation systems.

### BACKGROUND OF THE INVENTION

Mobile fluoroscopy imaging and surgical navigation are two high technology tools used in operating rooms (OR) around the world to provide interventional imaging and image guidance during surgery. An integrated fluoroscopy imaging and navigation system provides the physician with fluoroscopic images during diagnostic, surgical and interventional procedures. The integrated system with a single workstation reduces hardware and electronics duplications that occur with two separate workstations with very similar user requirements. A single workstation that integrates imaging and navigation, uses less operating room real estate, and has the potential to improve the workflow by integrating applications.

The recording of full resolution video is not an option in both surgical navigation and fluoroscopic imaging systems. Currently, there is no way to capture and replay a full resolution video clip in a surgical navigation system, a fluoroscopic imaging system or an integrated fluoroscopy/imaging and navigation system. External video ports provide down sampled low resolution video (NTSC and PAL) for off-line recording and playback. The high resolution digital data is converted to low resolution analog data, and much image fidelity is lost. A low resolution sequence can be captured with a VCR or frame capture device in NTSC or PAL format. In surgical navigation, applications with native SXGA (1280×1024) or UXGA (1600×1200) graphics resolutions can be found in most systems. Although it is possible to export single image snapshots at full resolution, using digital computer standard file formats, motion video capture is still provided at National Television Standards Committee (NTSC) or at Phase Alternation Line (PAL) standard resolution through an analog video port.

For the reasons stated above, and for other reasons stated below which will become apparent to those skilled in the art upon reading and understanding the present specification, there is a need in the art for the capture, recording, storage and replay of full resolution video in surgical navigation and fluoroscopic imaging systems. There is also a need for a recording method or apparatus that effectively allows a user to decide to record an event after the event has taken place.

### BRIEF DESCRIPTION OF THE INVENTION

The above-mentioned shortcomings, disadvantages and problems are addressed herein, which will be understood by reading and studying the following specification.

In accordance with an aspect, a method for recording images obtained by a fluoroscopic imaging and navigation apparatus, the method comprising receiving a plurality of digital images from the fluoroscopic imaging and navigation apparatus; capturing the plurality of digital images from the fluoroscopic imaging and navigation apparatus; and buffering the captured plurality of digital images.

In accordance with another aspect, a system for recording of images obtained by a fluoroscopic imaging and navigation apparatus comprising a processor; a storage device coupled to the processor; and software means operative on the processor for receiving a plurality of digital images from the fluoroscopic imaging and navigation apparatus; capturing the plurality of digital images from the fluoroscopic imaging and navigation apparatus; and buffering the captured plurality of digital images from the imaging and navigation apparatus.

In accordance with yet another aspect, a computer-accessible medium having executable instructions for recording of images obtained by a fluoroscopic imaging and navigation apparatus, the executable instructions capable of directing a processor to perform receiving a plurality of digital images from the fluoroscopic imaging apparatus; capturing the plurality of digital images from the fluoroscopic imaging apparatus; buffering the captured plurality of digital images in an acquisition buffer having a predetermined size on a recording medium; replacing the captured plurality of digital images in the acquisition buffer with a next captured plurality of digital images in the acquisition buffer when a total plurality of digital images exceeds the size of the recording medium; wherein the captured plurality of digital images is acquired at one or more of a full frame rate, a lower frame rate, or at a navigation system sample rate.

In accordance with a further aspect, a system for recording of images obtained by a fluoroscopic imaging apparatus comprising: a processor; a storage device coupled to the processor; and software means operative on the processor for: receiving a plurality of digital images from the fluoroscopic imaging apparatus; and capturing the plurality of digital images from the fluoroscopic imaging apparatus.

In accordance with another further aspect, a system for recording of images obtained by a medical navigation apparatus comprising: a processor; a storage device coupled to the processor; and software means operative on the processor for receiving a plurality of digital images from the medical navigation apparatus; and capturing the plurality of digital images from the medical navigation apparatus.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a diagram illustrating a system-level overview of an embodiment;

FIG. 2 is a diagram illustrating a system-level overview of another embodiment;

FIG. 3 is a diagram illustrating a system-level overview of yet another embodiment;

FIG. 4 is a block diagram of the hardware and operating environment in which different embodiments can be practiced;

FIG. 5 is a flowchart of a method according to an embodiment;

FIG. 6 is a flowchart of a method according to another embodiment;

FIG. 7 is a flowchart of a method according to another embodiment;

FIG. 8 is a view of a display with functions for recording events according to an embodiment; and

FIG. 9 is a display from a navigation system showing image views with dynamic tool position and orientation information.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

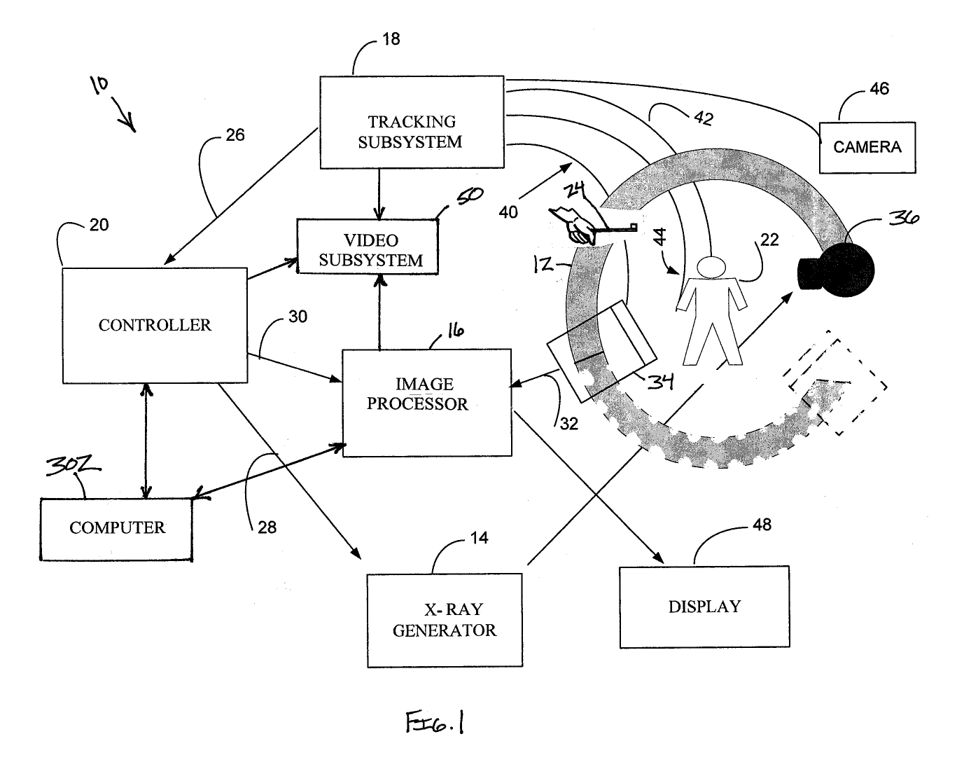

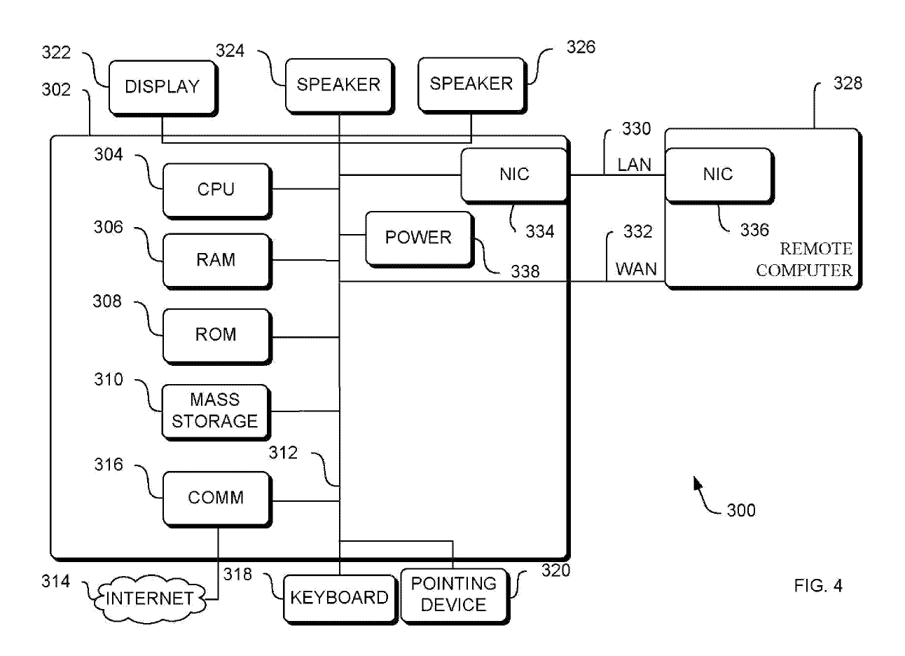

FIG. 1 is a block diagram that provides a system level overview of an integrated fluoroscopy imaging and navigation system. Embodiments are described as operating in a multi-processing, multi-threaded operating environment on a computer, such as computer 302 in FIG. 4.

FIG. 1 illustrates an integrated fluoroscopy imaging and navigation system 10 that includes an imaging apparatus 12 that is electrically connected to an x-ray generator 14, an image processor 16 and a tracking subsystem 18. A controller 20 communicates with x-ray generator 14, image processor 16, video subsystem 50 and computer 302. The image processor 16 communicates with a display 48 and computer 302. The imaging apparatus 12 includes an x-ray source 36 mounted to one side and an x-ray detector 34 mounted to the opposed side. The imaging apparatus 12 is movable in several directions along multiple image acquisition paths such as an orbital tracking direction, longitudinal tracking direction, lateral tracking direction, transverse tracking direction, pivotal tracking direction, and wig-wag tracking direction.

The tracking subsystem 18 monitors the position of the patient 22, the detector 34, and an instrument or tool 24 used by a medical professional during a diagnostic or interventional surgical procedure. The tracking subsystem 18 provides tracking component coordinates 26 with respect to each of the patient 22, detector 34, and instrument 24 to the controller 20. The controller 20 uses the tracking component coordinates 26 to continuously calculate the positions of the detector 34, patient 22, and instrument 24 with respect to a coordinate system defined relative to a coordinate system reference point. The reference point for the coordinate system is dependent, in part, upon the type of tracking subsystem 18 used. The controller 20 sends control or trigger commands 28 to the x-ray generator 14 that in turn causes one or more exposures to be taken by the x-ray source 36 and detector 34. The controller 20 provides exposure reference data 30 to the image processor 16. The control or trigger commands 28 and exposure reference data 30 are generated by the controller 20, as explained in more detail below, based on the tracking component coordinates 26 as the imaging apparatus is moved along an image acquisition path.

By way of example, the imaging apparatus 12 may be manually moved between a first and second positions (P1, P2) as a series of exposures are obtained. The image acquisition path may be along the orbital rotation direction and the detector 34 may be rotated through a range of motion from zero (0) to 145 degrees or from 0 to 190 degrees.

The image processor 16 collects a series of image exposures 32 from the detector 34 as the imaging apparatus 12 is rotated. The detector 34 collects an image exposure 32 each time the x-ray source 36 is triggered by the x-ray generator 14. The image processor 16 combines each image exposure 32 with corresponding exposure reference data 30 and uses the exposure reference data 30 to construct a three-dimensional volumetric data set as explained below in more detail. The three-dimensional volumetric data set is used to generate images, such as slices, of a region of interest from the patient. For instance, the image processor 16 may produce from the volumetric data set saggital, coronal and/or axial views of a patient spine, knee, and the like.

The tracking subsystem 18 receives position information from detector, patient and instrument position sensors 40, 42 and 44, respectively. The sensors 40-44 may communicate with the tracking subsystem 18 via hardwired lines, infrared, wireless or any known or to be discovered method for scanning sensor data. The sensors 40-44 and tracking subsystem 18 may be configured to operate based on one or more communication medium such as electromagnetic, optics, or infrared.

As shown an electromagnetic (EM) implementation a field transmitter/generator is provided with up to three orthogonally disposed magnetic dipoles. The magnetic fields generated by each of these dipoles are distinguishable or ID from one another through phase, frequency or time division multiplexing. The magnetic fields may be relied upon for position detection. The field transmitter/generator may form any one of the patient position sensor 42, detector position sensor 40 or instrument position sensor 44. The field transmitter/generator emits EM fields that are detected by the other two of the position sensors 40-44. By way of example, the patient position sensor 42 may comprise the field transmitter/generator, while the detector and instrument position sensors 40 and 44 comprise one or more field sensors each.

The sensors 40-44 and tracking subsystem 18 may be configured based on optical or infrared signals. A position monitoring camera 46 can be added to monitor the position of the sensors 40-44 and to communicate with the tracking subsystem 18. An active infrared light may be periodically emitted by each sensor 40-44 and detected by the position monitoring camera 46. Alternatively, the sensors 40-44 may operate in a passive optical configuration, whereby separate infrared emitters are located at the camera 46 and/or about the room. The emitters are periodically triggered to emit infrared light. The emitted infrared light is reflected from the sensors 40-44 onto one or more cameras 46. The active or passive optical information collected through the cooperation of the sensors 40-44 and position monitoring camera 46 is used by the tracking subsystem 18 define tracking component coordinates for each of the patient 22, detector 34 and instrument 24. The position information may define six degrees of freedom, such as x, y, z coordinates and pitch, roll and yaw angular orientations. The position information may be defined in the polar or Cartesian coordinate systems.

Notwithstanding the communication medium used, the tracking subsystem 18 generates a continuous stream of tracking component coordinates, such as the Cartesian coordinates, pitch, roll and yaw for the instrument (I(x, y, z, pitch, roll, yaw)), for the detector 34 D(x, y, z, pitch, roll, yaw), and/or patient 22 P(x, y, z, pitch, roll, yaw). When the patient position sensor 42 is provided with an EM transmitter therein, the coordinate reference system may be defined with the origin at the location of the patient position sensor 42. When an infrared tracking system is used, the coordinate system may be defined with the point of origin at the patient monitoring camera 46.

The controller 20 continuously collects the stream of tracking component coordinates 26 and continuously calculates the position of the patient 22, detector 34 and instrument 24 relative to a reference point. The controller 20 may calculate rotation positions of the imaging apparatus and store each such position temporarily. Each new rotation position may be compared with a target position, representing a fixed angular position or based on a fixed accurate movement. When a 3-D acquisition procedure is initiated, the controller 20 establishes a reference orientation for the imaging apparatus 12. For instance, the controller 20 may initiate an acquisition process once the detector 34 is moved to one end of an image acquisition path with beginning and ending points corresponding to a 0 degree angle and 190 degree angle, respectively. Alternatively, the controller 20 may initialize the coordinate reference system with the imaging apparatus 12 located at an intermediate point along its range of motion. In this alternative embodiment, the controller 20 defines the present position of the detector 34 as a starting point for an acquisition procedure. Once the controller 20 establishes the starting or initial point for the image acquisition procedure, a control or trigger command 28 is sent to the x-ray generator 14 and initial exposure reference data 30 is sent to the image processor 16. An initial image exposure 34 is obtained and processed.

After establishing an initial position for the detector 34, the controller 20 continuously monitors the tracking component coordinates 26 for the detector 34 and determines when the detector 34 moves a predefined distance. When the tracking component coordinates 26 indicate that the detector 34 has moved the predefined distance from the initial position, the controller 20 sends a new control or trigger command 28 to the x-ray generator 14 thereby causing the x-ray source 36 to take an x-ray exposure. The controller 20 also sends new exposure reference data 30 to the image processor 16. This process is repeated at predefined intervals over an image acquisition path to obtain a series of images. The image processor 16 obtains the series of image exposures 32 that correspond to a series of exposure reference data 30 and combines the data into a volumetric data set that is stored in memory.

The controller 20 may cause the x-ray generator 14 and image processor 16 to obtain image exposures at predefined arc intervals during movement of the detector 34 around the orbital path of motion. The orbital range of motion for the detector 34, over which images are obtained, may be over a 145 degree range of motion or up to a 190 degree range of motion for the imaging apparatus 12. Hence, the detector 34 may be moved from a zero angular reference point through 145 degree of rotation while image exposures 32 are taken at predefined arc intervals to obtain a set of image exposures used to construct a 3-D volume. Optionally, the arc intervals may be evenly spaced apart at 1 degree, 5 degree, 10 degree and the like, such that approximately 100, 40, or 15, respectively, image exposures or frames are obtained during movement of the detector 34 through rotation. The arc intervals may be evenly or unevenly spaced from one another. In the alternative, the operator at any desired speed may manually move the detector 34. The operator may also move the detector 34 at an increasing, decreasing, or at a variable velocity since exposures are triggered only when the detector 34 is located at desired positions that are directly monitored by the tracking subsystem 18.

Integrated within the fluoroscopy imaging and navigation system 10 is the video subsystem 50 for capturing, recording, storing and replaying full resolution video of procedures occurring on the fluoroscopy imaging and navigation system 10. The video subsystem 50 is coupled to image processor 16, tracking subsystem 18, controller 20 and computer 302.

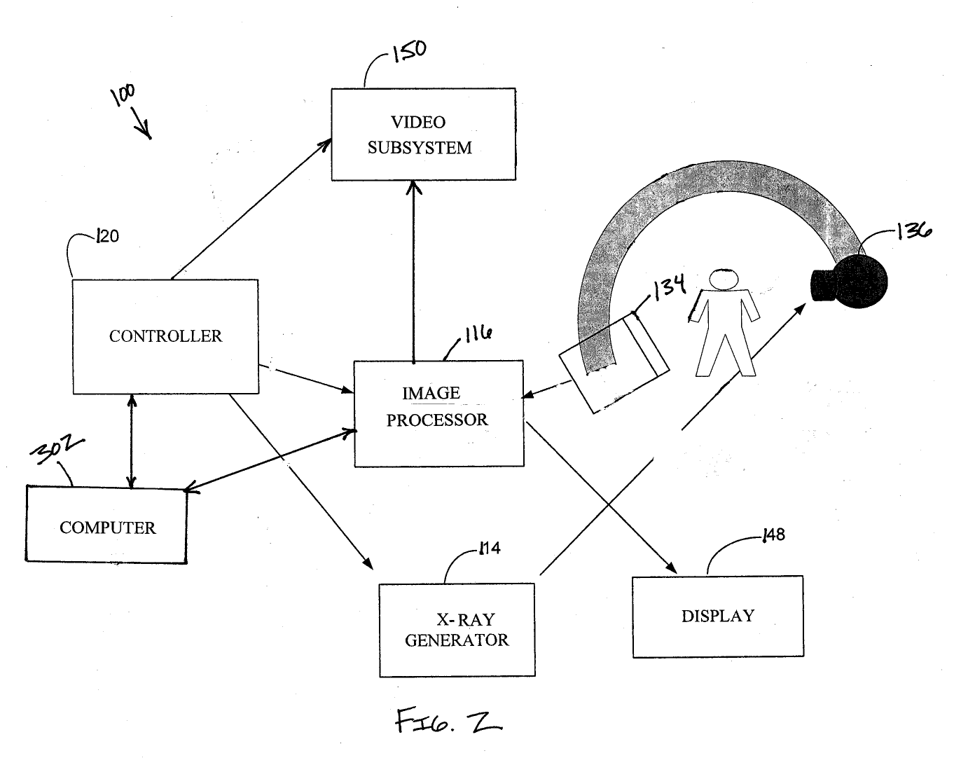

FIG. 2 illustrates a fluoroscopy imaging system 100 that includes an imaging apparatus 112 that is electrically connected to an x-ray generator 114 and an image processor 116. A controller 120 communicates with x-ray generator 114, image processor 116, video subsystem 150 and computer 302. The image processor 116 communicates with a display 148 and computer 302. The imaging apparatus 112 includes an x-ray source 136 mounted to one side and an x-ray detector 134 mounted to the opposed side.

Integrated within the fluoroscopy imaging system 100 is the video subsystem 150 for capturing, recording, storing and replaying full resolution video of procedures occurring on the fluoroscopy imaging system 100. The video subsystem 150 is coupled to image processor 116, controller 120 and computer 302.

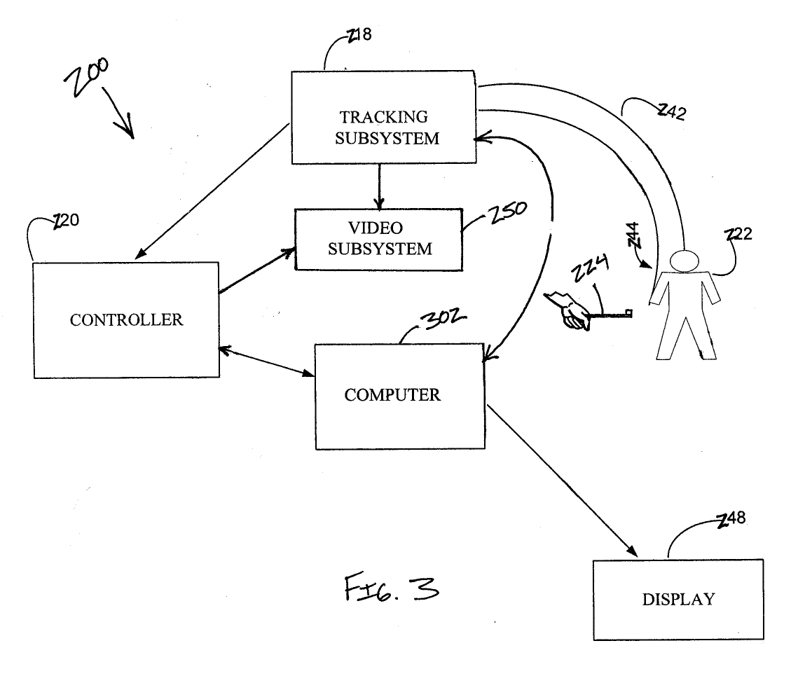

FIG. 3 illustrates a medical navigation system 200 that includes a tracking subsystem 218, a controller 220, a video subsystem, 250, a computer 302 and a display 248. The tracking subsystem 218 provides tracking component coordinates with respect to each of the patient 222, instrument 224 and sensors 242, 244 to the controller 220. The controller 220 uses the tracking component coordinates to continuously calculate the positions of the patient 222, instrument 224 and sensors 242, 244 with respect to a coordinate system defined relative to a coordinate system reference point.

The tracking subsystem 218 receives position information from sensors 242 and 244. The sensors 242 and 244 may communicate with the tracking subsystem 218 via hardwired lines, infrared, wireless or any known or to be discovered method for scanning sensor data. The sensors 242 and 244 and tracking subsystem 218 may be configured to operate based on one or more communication medium such as electromagnetic, optics, or infrared.

Integrated within the medical navigation system 200 is the video subsystem 250 for capturing, recording, storing and replaying full resolution video of procedures occurring on the medical navigation system 200. The video subsystem 250 is coupled to tracking subsystem 218, controller 220 and computer 302.

The video subsystem is designed specifically for medical imaging and navigation applications, and not as an offshoot of commercial or home entertainment components. The video subsystem conveniently integrates with existing imaging modalities such as X-ray, ultrasound, computed tomography (CT), and magnetic resonance (MR) imaging systems for capturing, recording, storing and replaying full resolution medical images and video to recordable media or storage media. Additionally, the video subsystem has the capability of compressing the images and video using various compression formats, such as MPEG compression, JPEG compression, vector graphics compression, Huffman coding, or H.261 compression, for example.

The video subsystem provides a compact integrated system for use with both portable or mobile imaging and medical navigation systems, and fixed imaging modalities. For fixed imaging modalities, the video subsystem may be coupled directly to the imaging modality or coupled to a network that interfaces with the imaging modality for recording medical images and video from the fixed imaging modality onto storage media or a recording medium. In the case of a mobile imaging system or a medical navigation system, the video subsystem may be coupled to the mobile imaging system or the medical navigation system for recording medical images and video from the mobile imaging system or the medical navigation system onto storage media or a recording medium. The recorded medical images and video is available for replay and viewing during or after a procedure. The recording of this video of procedures could be maintained in a digital repository for auditing the performance of the operator, surgeon, or procedure. The video subsystem simplifies the video recording process allowing a user to easily record still images, loops and cine continuously, with the touch of a button, or with the use of a footswitch. Offering both retrospective and prospective record modes supports the capture of user specified seconds or minutes of image data immediately preceding or following the desired event. The video subsystem also allows for continuous linear recording of long dynamic runs or one-button capture of single frames directly from streaming video data. The video subsystem efficiently and automatically manages the image recording process allowing the user to concentrate on observation, diagnosis, and performing the procedure. The video subsystem eliminates the tedious and time consuming review and rewinding process to get to a few seconds of important data. Using various recording modes reduces the amount of non-essential image data captured, and allows a user to focus on the most crucial clinical data.

FIG. 4 is a block diagram of the hardware and operating environment 400 in which different embodiments can be practiced. The description of FIG. 4 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in memory. Some embodiments can also be implemented in client/server computing environments where remote devices that perform tasks are linked through a communications network. Program modules can be located in both local and remote memory storage devices in a distributed computing environment.

Computer 302 includes a processor 304, random-access memory (RAM) 306, read-only memory (ROM) 308, and one or more mass storage devices 310, and a system bus 312, that operatively couples various system components to the processor 304. The memory 306, 308, and mass storage devices, 310, are types of computer-accessible media. Mass storage devices 310 are more specifically types of nonvolatile computer-accessible media and can include one or more hard disk drives, floppy disk drives, optical disk drives, and tape drives. The processor 304 executes computer programs stored on computer-accessible media.

Computer 302 can be communicatively connected to the Internet 314 via a communication device 316. Internet 314 connectivity is well known within the art. In one embodiment, a communication device 316 is a modem that responds to communication drivers to connect to the Internet via what is known in the art as a “dial-up connection.” In another embodiment, a communication device 316 is an Ethernet or similar hardware network card connected to a local-area network (LAN) that itself is connected to the Internet via what is known in the art as a “direct connection” (e.g., T1 line, etc.).

A user enters commands and information into the computer 302 through input devices such as a keyboard 318 or a pointing device 320. The keyboard 318 permits entry of textual information into computer 302, as known within the art, and embodiments are not limited to any particular type of keyboard. Pointing device 320 permits the control of the screen pointer provided by a graphical user interface (GUI) of operating systems, such as versions of Microsoft Windows®. Embodiments are not limited to any particular pointing device 320. Such pointing devices include mice, touch screens, touch pads, trackballs, remote controls and point sticks. Other input devices (not shown) can include a microphone, joystick, game pad, satellite dish, scanner, or the like.

In some embodiments, computer 302 is operatively coupled to a display device 322. Display device 322 is connected to the system bus 312. Display device 322 permits the display of information, including computer, video and other information, for viewing by a user of the computer. Embodiments are not limited to any particular display device 322. Such display devices include cathode ray tube (CRT) displays (monitors), as well as flat panel displays such as liquid crystal displays (LCD's). In addition to a monitor, computers typically include other peripheral input/output devices such as printers (not shown). Speakers 324 and 326 provide audio output of signals. Speakers 324 and 326 are also connected to the system bus 312.

Computer 302 also includes an operating system (not shown) that is stored on the computer-accessible media RAM 306, ROM 308, and mass storage device 310, and is and executed by the processor 304. Examples of operating systems include Microsoft Windows®, Apple MacOS®, Linux®, UNIX®. Examples are not limited to any particular operating system, however, and the construction and use of such operating systems are well known within the art.

Embodiments of computer 302 are not limited to any type of computer 302. In varying embodiments, computer 302 comprises a PC-compatible computer, a MacOS®-compatible computer, a Linux®-compatible computer, or a UNIX®-compatible computer. The construction and operation of such computers are well known within the art.

Computer 302 can be operated using at least one operating system to provide a graphical user interface (GUI) including a user-controllable pointer. Computer 302 can have at least one web browser application program executing within at least one operating system, to permit users of computer 302 to access intranet or Internet world-wide-web pages as addressed by Universal Resource Locator (URL) addresses. Examples of browser application programs include Netscape Navigator® and Microsoft Internet Explorer®.

The computer 302 can operate in a networked environment using logical connections to one or more remote computer 328. These logical connections are achieved by a communication device coupled to, or a part of, the computer 302. Embodiments are not limited to a particular type of communications device. The interface 350 can be a remote computer, a server, a router, a network PC, a client, a peer device or other common network node. The logical connections depicted in FIG. 4 include a local-area network (LAN) 330 and a wide-area network (WAN) 332. Such networking environments are commonplace in offices, enterprise-wide computer networks, intranets and the Internet.

When used in a LAN-networking environment, the computer 302 and interface 350 are connected to the local network 330 through network interfaces or adapters 334, which is one type of communications device 316. The interface 350 may also include a network device 336. When used in a conventional WAN-networking environment, the computer 302 and remote computer 328 communicate with a WAN 332 through modems (not shown). The modem, which can be internal or external, is connected to the system bus 312. In a networked environment, program modules depicted relative to the computer 302, or portions thereof, can be stored in a remote computer.

Computer 302 also includes power supply 338. The power supply 338 may be an internal power supply or a battery.

In the previous descriptions of embodiments, (FIGS. 1-3) system level overviews of the operation of these embodiments were described. The particular methods performed by the data processing system of such an embodiment are described by reference to a series of flowcharts. Describing the methods by reference to a flowchart enables one skilled in the art to develop such programs, firmware, or hardware, including such instructions to carry out the methods on suitable computerized systems, with a processor executing the instructions from computer-readable media. The computer readable medium can be electronic, magnetic, optical, electromagnetic, or infrared systems, apparatus, or devices. An illustrative, but non-exhaustive list of computer-readable mediums can include an electrical connection having one or more wires, a portable computer disk, a random access memory (RAM), a read-only memory (ROM), an erasable programmable read-only memory (EPROM or Flash memory), an optical fiber, and a portable compact disk read-only memory (CDROM). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory. Similarly, the methods performed by the server computer programs, firmware, or hardware are also composed of computer-executable instructions. Methods 400 and 500 are performed by a program executing on, or performed by firmware or hardware that is a part of, a computer, such as computer 302 in FIG. 1-4, and is inclusive of the acts required to be taken by the processor.

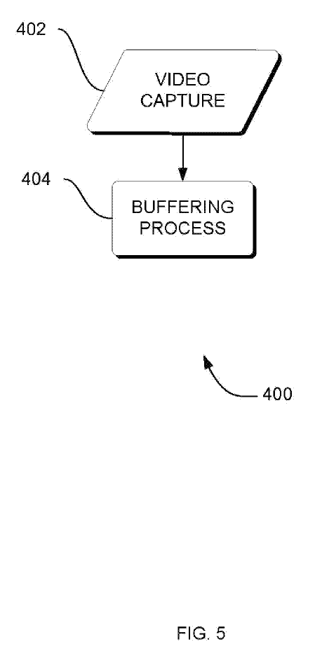

FIG. 5 is a flowchart of a method 400 performed according to an embodiment. Method 400 meets the need in the art for the capturing and recording of full resolution video in medical imaging and navigation systems.

Method 400 includes the capturing of video at action 402 and a buffering at action 406 of the captured video.

In action 402 video capturing is performed. The action of video capture is the receiving of a plurality of video signals from a medical imaging system, a medical navigation system, or an integrated imaging and navigation system. A video subsystem coupled to a medical imaging system, a medical navigation system, or an integrated imaging and navigation system includes a frame grabber or video capturing device for capturing a plurality of video images from the medical imaging system, a medical navigation system, or an integrated imaging and navigation system and converting the plurality of video images into a plurality of digital images. The video capturing can be at full range of medical video sources. The video capturing can also be interlaced and non-interlaced video sources as well as VGA and other video signals. The video capturing is able to capture the broadcast standard formats, such as S-Video and color composite sources. The ability to capture video at such high resolution results in the playback of images that are identical to the original source and without the drawbacks of scan conversion or reduced image resolution. The video capturing without introducing a loss of image quality results in output that is equal to that of the original imaging exam data. The imaging data is received and recorded at the highest bandwidth from the imaging modality so that each exam copy is exactly like the original. The video capturing can accommodate many desired rates such as full frame rates, lower frame rates, navigation system sample rates, or other defined rates. The video capturing may also be triggered by a data variation between frame T(n) and T(n−1), or controlled by an external event, such as “x-ray on” or “tracking on”. Once the video has been capture in action 402 control passes to action 404 for further processing.

In action 404, buffering is performed. The buffering process 404 is the act of recording information. A user can set or the system can come preset from the factory with a finite buffer in the video subsystem. The finite buffer will store all information (video, text, images) for a fixed period of time.

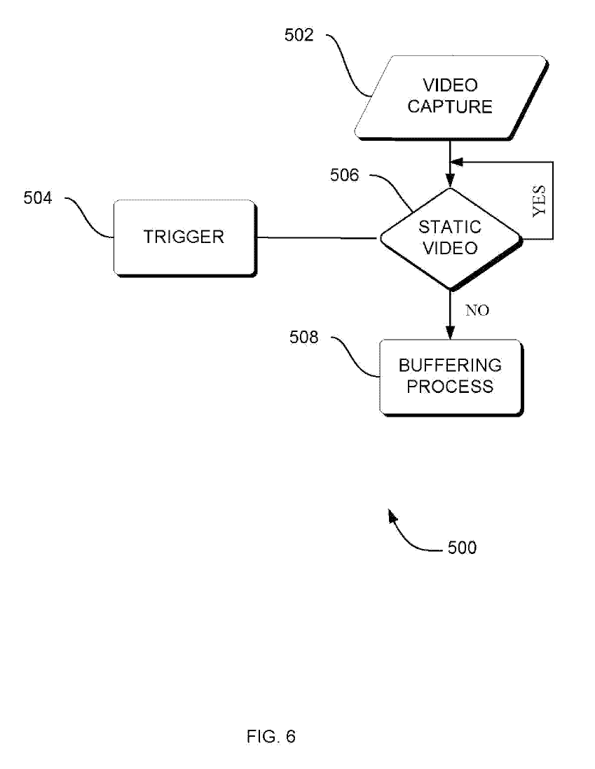

FIG. 6 is a flowchart of a method 500 performed by a client 302 according to an embodiment. Method 500 meets the need in the art for the recording of full resolution video in surgical navigation and fluoroscopic imaging.

Method 500 includes the capturing of video at action 502, the determination of a triggering event at action 504, a determination if the triggering event had been activated at action 506, and a buffering at action 508 of the captured video upon the triggering event being activated.

In action 502 video capturing is performed. Once the video is captured control passes to action 506 for further processing.

In action 504, a triggering event is determined. This determination can be based on an ‘x-ray on’ signal, tracking on signal, statistical decision signal, or a switch signal initiated by the user. The statistical decision can be based on comparing the information content of frames (variation) or a series of frames to determine if a change has occurred. When there is no significant change between successive frames there is no need to store the video. This action prevents static video from being stored and to an increase of storage capacity available for preserving video data after a triggering condition. Once the triggering condition has been determined at action 504 control passes to action 506 for further processing.

In action 506, a static video condition is determined. The static video condition is based ideally on having captured video from action 502 and a negative triggering event from action 505. However, in the current arrangement if a triggering event is not indicated then the assumption is that a static video condition is present and control is returned to action 502 for further processing. When there is an indication that a triggering event is present (‘x-ray on’, tracking on, a switch is activated) control is passed to action 508 for further processing.

In action 508, buffering is performed. The buffering process 508 is the act of recording information after the triggering event has happened. A user can set or the system can come preset from the factory with a finite buffer on the video capturing system 100. The finite buffer will store all information (video, text, images) for a fixed period of time.

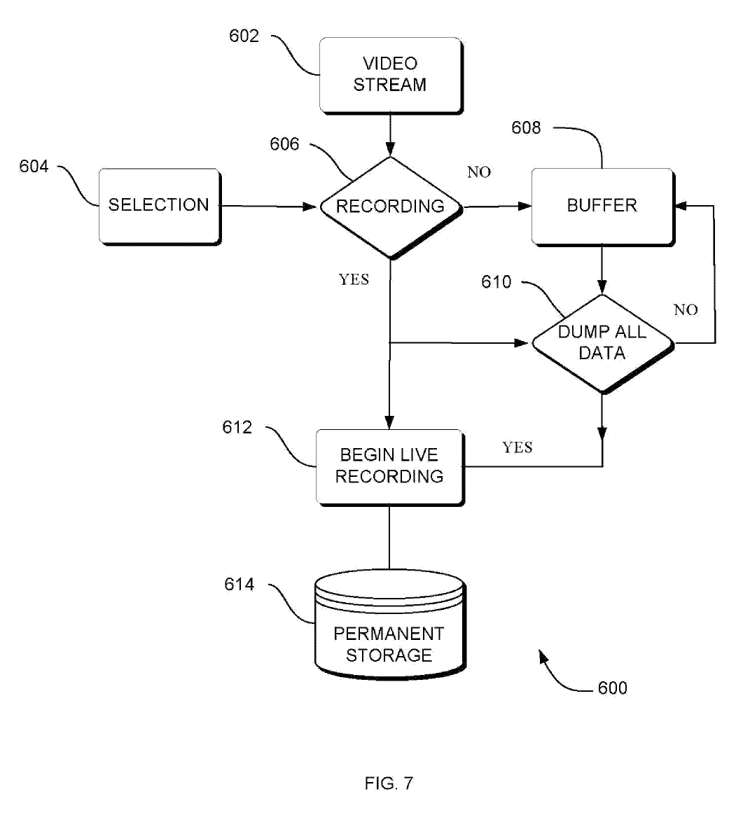

FIG. 7 is a flowchart of a method 600 performed according to an embodiment. Method 600 meets the need in the art for capturing and recording full resolution video in medical imaging and navigation systems. Method 600 addresses the buffering operation and the recording of the video data in a permanent location.

Method 600 begins with receipt of the captured video data in action 402. The capture data is referred to as a video stream to highlight the fact that data is being continuously streamed. In operation, an incoming video stream is buffered in a FIFO buffer at a predetermined frame rate. The video stream consists of a series of frames. As shown in methods 400 and 500 the streaming video is buffered (action 608) until a determination is made (actions 604 and 606) that a permanent recording of the video should be undertaken. Action 604 registers the selection for permanent storage of the captured video. The selection could be based on a stimulus received through a user interface preferably having VCR like functions, a physical switch, or system activated signal such as a triggering event (action 504). In an embodiment, a user can select through an interface to permanently record an event. When an event is selected for recording all buffered data would be transferred to a permanent storage such as a hard disk drive, DVD or CDROM (610, 612, 614). In general, recorded video data may be preserved by writing the video data to any storage medium, such as a hard disk, tape, RAM, flash memory, or non-volatile solid-state memory. Recorded video data may be preserved at any time between the decision to capture (triggering event 504) and the time that the data is overwritten in the circular buffer; however, deferring storage until the acquisition buffer is about to be overwritten facilitates giving the user the ability to cancel the decision to capture a block of data. The capture interval and the time interval that may be captured before the user's decision to record is a function of the quantity of recording medium and the recording density. If captured data, rather than being transferred out of the acquisition buffer, is stored in a newly reserved area of the acquisition buffer, then the capture interval will diminish as this area becomes filled with captured data. This newly reserved area can be dynamically acquired by simply re-mapping that portion of memory outside of the FIFO buffer, so that the buffer will not be overwritten with data from the incoming video stream.

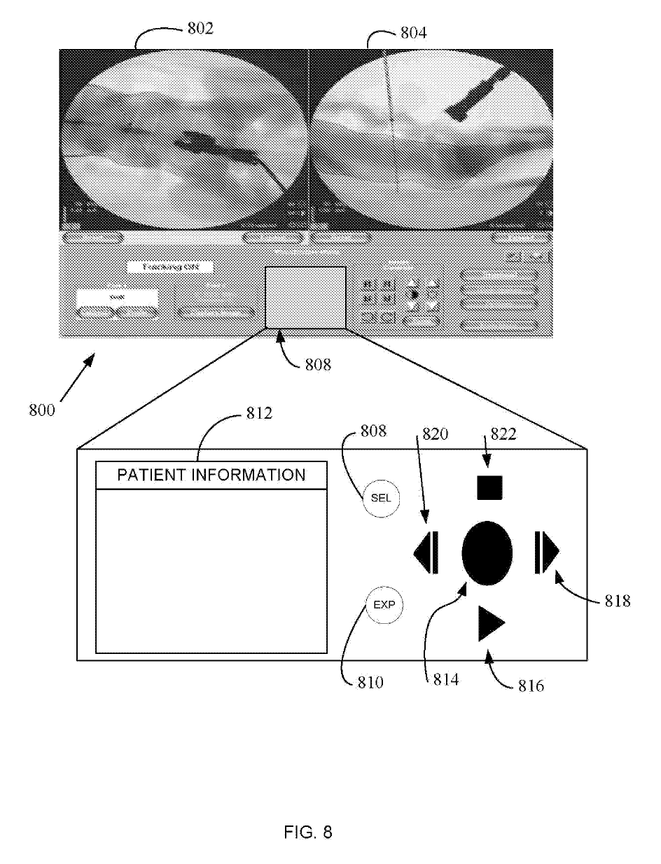

FIG. 8 is an illustration of a display 800 from a fluoroscopic imaging and navigation system showing two fluoroscopic image views 802, 804 with dynamic tool position, orientation and extended trajectory information, and a user interface 808. The user interface 808 allows a user to select information about the patient and for controlling the recording of video. Most importantly item 818 includes VCR like functions for stopping, pausing, playing, recording, rewinding, fast forwarding, and skipping the video. Display 800 illustrates the recording process during a procedure of an identifiable patient. User interface button 808 is used to select from the list of patient information in user interface patient information box 812. User interface button 810 is used to view an expansion of any selected category. VCR like button 814 through 822 illustrates the operating procedure of the video capture device for recording and playing the captured video. After buffering the video the user may wish to record the content, the user presses a “Record” button 814 to cause a dump of all data from the buffer to a permanent recording medium. To view the content a user presses a “Play” button 816. The user presses a “Forward Play” button 818 to advance through the content. The user presses a “Backward Play” button 820 to reverse direction. To stop the process, the user presses a “Stop” button 822. One skilled in the art would appreciate that these various buttons can be omitted or rearranged or adapted in various ways. For instance, if the Play button performs both playing and recording, the Record button can be omitted. The buttons can also be used to record or select a desired portion of the captured video for recording. For example, when viewing buffered video data the user with the forward or backward buttons (818, 820) can navigate to a section of the buffered data and then select that section for recording. In playback mode the user can view the procedure of a particular patient, select the patient name and procedure and press the Play button at 816 to play the video of the recorded procedure.

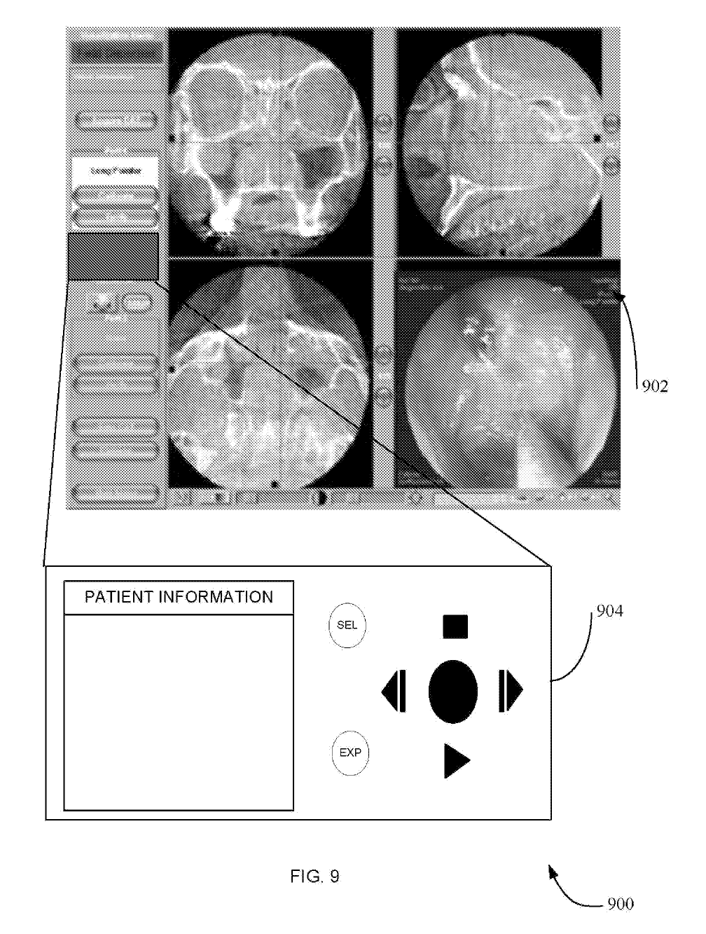

FIG. 9 is a display 900 from a navigation system showing four image views 902, three pre-acquired images with dynamic tool position and orientation information, a dynamic (live) endoscopic video view, and a user interface 904. The user interface 904 allows a user to select information about the patient and for controlling the recording of video. Most importantly, it includes VCR like functions for stopping, pausing, playing, recording, rewinding, fast forwarding, and skipping the video. After buffering the video the user may wish to record the content, the user presses a “Record” button to cause a dump of all data from the buffer to a permanent recording medium. To view the content a user presses a “Play” button. The user presses a “Forward Play” button to advance through the content. The user presses a “Backward Play” button to reverse direction. To stop the process, the user presses a “Stop” button.

The video subsystem described in the various embodiments above, may reduce x-ray dose and may possibly reduce the amount of contrast agent used in imaging, by reducing the number of “re-takes” due to operator error, and/or transient radiographic events like contrast agent dissipation. In addition, the video subsystem described above, solves the problem of not knowing what or when to record video by continuously buffering large amounts of video data to a buffer for recording and storage.

In some embodiments, methods 400, 500, and 600 are implemented as a computer data signal embodied in a carrier wave, that represents a sequence of instructions which, when executed by a processor, cause the processor to perform the respective method. In other embodiments, methods 400, 500, and 600 are implemented as a computer-accessible medium having executable instructions capable of directing a processor to perform the respective method. In varying embodiments, the medium is a magnetic medium, an electronic medium, or an optical medium.

The system components of the video subsystem can be embodied as electronic circuitry or components, as a computer-readable program, or a combination of both.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer, or on at least as many computers as there are components.

### CONCLUSION

A video subsystem for a medical imaging and navigation system has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in object-oriented terms, one of ordinary skill in the art will appreciate that implementations can be made in a procedural design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

We claim:

1. A method for recording images obtained by a fluoroscopic imaging and navigation apparatus, the method comprising:
receiving a plurality of digital images from the fluoroscopic imaging and navigation apparatus;
capturing the plurality of digital images from the fluoroscopic imaging and navigation apparatus; and
buffering the captured plurality of digital images.

2. The method of claim 1, further comprising receiving a triggering event that is one or more of an x-ray on event, a tracking on event, an interframe variation event, or a user defined trigger event.

3. The method of claim 1, wherein the step of capturing the plurality of digital images is acquired at one or more of a full frame rate, a lower frame rate, or a navigation system sample rate.

4. The method of claim 1, wherein the step of buffering the captured plurality of digital images further comprises:
continuously storing the captured plurality of digital images in an acquisition buffer having a predetermined size on a recording medium; and,
replacing the captured plurality of digital images in the acquisition buffer with a next captured plurality of digital images in the acquisition buffer when a total plurality of digital images exceeds the size of the recording medium.

5. The method of claim 4, further comprising:
selecting a portion of the stored plurality of digital images in the acquisition buffer; and,
preserving the selected portion of the stored plurality of digital images in the acquisition buffer.

6. The computerized method of claim 5, wherein the step of preserving the selected portion of the stored plurality of digital images in the acquisition buffer further comprises:
reserving the selected portion of the stored plurality of digital images in the acquisition buffer from being overwritten; or,
transferring the selected portion of the stored plurality of digital images in the acquisition buffer to a predetermined location such as a hard drive, a flash memory, a data repository, or an external data storage device.

7. The method of claim 5, wherein the step of selecting a portion of the stored plurality of digital images in the acquisition buffer further comprises:
selecting the portion of the stored plurality of digital images in the acquisition buffer based on one or a combination of the triggering event, a user selection, or an inference model;
wherein the selected portion can be all of the plurality of digital images in the acquisition buffer, or a portion that is less than all of the plurality of digital images in the acquisition buffer.

8. The method of claim 6, wherein the step of transferring the selected portion of the stored plurality of digital images in the acquisition buffer to a predetermined location further comprises:
compressing the selected portion of the stored plurality of digital images in the acquisition buffer before transferring.

9. A system for recording of images obtained by a fluoroscopic imaging and navigation apparatus comprising:
a processor;
a storage device coupled to the processor; and,
software means operative on the processor for:
receiving a plurality of digital images from the fluoroscopic imaging and navigation apparatus;
capturing the plurality of digital images from the fluoroscopic imaging and navigation apparatus; and
buffering the captured plurality of digital images from the imaging and navigation apparatus.

10. The system of claim 9, further comprising receiving a triggering event that is one or more of an x-ray on event, a tracking on event, an interframe variation event, or a user defined trigger event.

11. The system of claim 9, wherein the captured plurality of digital images is acquired at one or more of a full frame rate, a lower frame rate, or a navigation system sample rate.

12. The system of claim 9, the system further comprising:
an acquisition buffer having a predetermined size on a recording medium for continuously storing the captured plurality of digital images; and,
replacing the captured plurality of digital images in the acquisition buffer with a next captured plurality of digital images in the acquisition buffer when a total plurality of digital images exceeds the size of the recording medium.

13. The system of claim 9, wherein the software means operative on the processor performing the additional function of:
selecting a portion of the stored plurality of digital images in the acquisition buffer; and,
preserving the selected portion of the stored plurality of digital images in the acquisition buffer.

14. The system of claim 13, wherein preserving the selected portion of the stored plurality of digital images in the acquisition buffer further comprises:
reserving the selected portion of the stored plurality of digital images in the acquisition buffer from being overwritten; or,
transferring the selected portion of the stored plurality of digital images in the acquisition buffer to a predetermined location such as a hard drive, a flash memory, a data repository, or an external data storage device.

15. The system of claim 13, wherein selecting a portion of the stored plurality of digital images in the acquisition buffer further comprises:
selecting the portion of the stored plurality of digital images in the acquisition buffer based on one or a combination of the triggering event, a user selection, or an inference model;
wherein the selected portion can be all of the plurality of digital images in the acquisition buffer, or a portion that is less than all of the plurality of digital images in the acquisition buffer.

16. The system of claim 14, wherein transferring the selected portion of the stored plurality of digital images in the acquisition buffer to a predetermined location further comprises:
compressing the selected portion of the stored plurality of digital images in the acquisition buffer before transferring.

17. The system of claim 12, wherein the recording medium is any one of a storage device coupled to the processor, a random access memory (RAM), a flash drive, a hard drive, a read only memory device, or a non-volatile memory device.

18. A computer-accessible medium having executable instructions for recording of images obtained by a fluoroscopic imaging and navigation apparatus, the executable instructions capable of directing a processor to perform:
receiving a plurality of digital images from the fluoroscopic imaging apparatus;
capturing the plurality of digital images from the fluoroscopic imaging apparatus;
buffering the captured plurality of digital images in an acquisition buffer having a predetermined size on a recording medium;
replacing the captured plurality of digital images in the acquisition buffer with a next captured plurality of digital images in the acquisition buffer when a total plurality of digital images exceeds the size of the recording medium;
wherein the captured plurality of digital images is acquired at one or more of a full frame rate, a lower frame rate, or at a navigation system sample rate.

19. The computer-accessible medium of claim 18, the processor further performing:
selecting a portion of the stored plurality of digital images in said acquisition buffer; and,
preserving the selected portion of the stored plurality of digital images in said acquisition buffer.

20. The computer-accessible medium of claim 19, wherein preserving the selected portion further comprises:
reserving the selected portion of said stored plurality of digital images from being overwritten; or,
transferring the selected portion to a predetermined location such as a hard drive, a flash memory, a data repository, or an external data storage device.

21. A system for recording of images obtained by a fluoroscopic imaging apparatus comprising:
a processor;
a storage device coupled to the processor; and,
software means operative on the processor for:
receiving a plurality of digital images from the fluoroscopic imaging apparatus; and
capturing the plurality of digital images from the fluoroscopic imaging apparatus.

22. A system for recording of images obtained by a medical navigation apparatus comprising:
a processor;
a storage device coupled to the processor; and,
software means operative on the processor for:
receiving a plurality of digital images from the medical navigation apparatus; and
capturing the plurality of digital images from the medical navigation apparatus.
